(19) United States
(12) Patent Application Publication
(10) Pub. No.: US 2026/0038090 A1
(43) Pub. Date: Feb. 5, 2026

(54) LOW-LIGHT MICROSCOPIC IMAGE ENHANCEMENT METHOD AND SYSTEM BASED ON SCANNING LIGHT FIELD

(71) Applicant: ZHEJIANG HEHU TECHNOLOGY CO., LTD., HANGZHOU (CN)

(72) Inventor: YI YANG, HANGZHOU (CN)

(21) Appl. No.: 19/288,374

(22) Filed: Aug. 1, 2025

(30) Foreign Application Priority Data
Aug. 2, 2024 (CN) 202411055036.X

(51) Int. Cl. G06T 5/50; G06T 5/60; G06T 5/70; G06T 7/55

(52) U.S. Cl. CPC G06T 5/50; G06T 5/60; G06T 5/70; G06T 7/55; G06T 2207/10052; G06T 2207/10056; G06T 2207/20081; G06T 2207/20084

(57) ABSTRACT

A low-light microscopic image enhancement method and system based on a scanning light field is provided, including specific steps of: acquiring data to be enhanced, where the data to be enhanced is low-light microscopic images of multiple angles of any sample; inputting the low-light microscopic images of multiple angles of the any sample into a depth reconstruction model to obtain a depth map of the any sample; pairing the depth map of the any sample with the low-light microscopic images of multiple angles of the any sample to obtain multiple depth map-low-light microscopic image pairs; inputting the multiple depth map-low-light microscopic image pairs into an image enhancement model to obtain high-signal-to-noise-ratio images of multiple angles of the any sample.

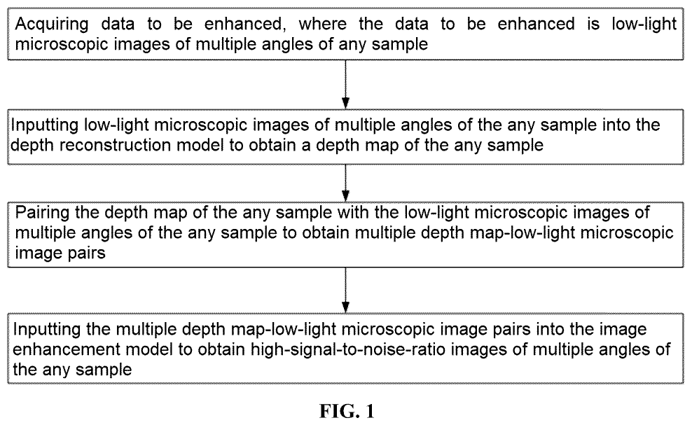

### CROSS REFERENCE TO RELATED APPLICATIONS

The present disclosure claims the priority to the Chinese patent application with the filing No. 202411055036.X, entitled “LOW-LIGHT MICROSCOPIC IMAGE ENHANCEMENT METHOD AND SYSTEM BASED ON SCANNING LIGHT FIELD” and filed on Aug. 2, 2024 with the Chinese Patent Office, the contents of which are incorporated herein by reference in their entirety.

### TECHNICAL FIELD

The present disclosure relates to the field of image enhancement technique, and more particularly to a low-light microscopic image enhancement method and system based on a scanning light field.

### BACKGROUND ART

How to reduce phototoxicity has always been one of the key issues that researchers in the field of microscopic imaging have focused on. Since light may cause irreversible photodamage to living tissues or cells, long-term living body microscopic observation techniques have been severely limited, greatly restricting the development of research fields such as brain science, immunology, oncology and pathology.

In the prior art, phototoxicity is mostly reduced by changing the illumination method (such as light sheet microscopy) and the acquisition method (such as light field microscope). Although light field microscope may achieve three-dimensional imaging of samples through a single shot, it sacrifices a certain spatial resolution. Scanning light field microscope may make up for the lack of spatial resolution through scanning, but also may not solve the impact of reduced illumination on image quality. Therefore, how to ensure the quality of microscopic images while reducing phototoxicity is a problem that a person skill in the art urgently needs to solve.

### SUMMARY

In view of this, the present disclosure provides a low-light microscopic image enhancement method and system based on a scanning light field, which overcome the above-mentioned defects.

In order to achieve the above purpose, the present disclosure adopts the following technical solutions.

A low-light microscopic image enhancement method based on a scanning light field includes the specific steps of:
acquiring data to be enhanced, where the data to be enhanced is low-light microscopic images of multiple angles of any sample;
inputting the low-light microscopic images of multiple angles of the any sample into a depth reconstruction model to obtain a depth map of the any sample;
pairing the depth map of the any sample with the low-light microscopic images of multiple angles of the any sample to obtain multiple depth map-low-light microscopic image pairs; and
inputting the multiple depth map-low-light microscopic image pairs into an image enhancement model to obtain high-signal-to-noise-ratio images of multiple angles of the any sample.

Optionally, the same training set is used in the training processes of the depth reconstruction model and the image enhancement model, and the training set includes the low-light microscopic images, the high signal-to-noise ratio images and the depth maps of multiple angles of various samples.

Optionally, the method for acquiring data in the training set includes:
performing multi-angle shooting on various samples to obtain the high-signal-to-noise-ratio images of multiple angles;
processing the high-signal-to-noise-ratio images of multiple angles by using a degradation and noise model to obtain the low-light microscopic images of multiple angles; and
using a light field depth estimation algorithm based on the high-signal-to-noise-ratio images of multiple angles to obtain the depth maps.

Optionally, the construction step of the depth reconstruction model includes:
constructing an initial depth reconstruction model based on a convolutional neural network; and
performing iterative training on the initial depth reconstruction model based on the low-light microscopic images of multiple angles and the corresponding depth maps to obtain the depth reconstruction model.

Optionally, the depth reconstruction model includes an image feature extraction module, a feature fusion module and a disparity regression module.

Optionally, the construction step of the image enhancement model includes:
constructing an initial image enhancement model based on a convolutional neural network; and
performing iterative training on the initial image enhancement model based on the depth map-low-light microscopic image pairs and the high-signal-to-noise-ratio images of multiple angles to obtain the image enhancement model.

Optionally, the image enhancement model includes an image feature extraction module, a depth feature extraction module, a feature fusion and enhancement module and a feature regression and reconstruction module.

A low-light microscopic image enhancement system based on a scanning light field includes:
a data acquisition module, used to acquire data to be enhanced, where the data to be enhanced is low-light microscopic images of multiple angles of any sample;
a depth reconstruction module, used to input the low-light microscopic image of multiple angles of the any sample into the depth reconstruction model to obtain a depth map of the any sample;
a data grouping module, used to pair the depth map of the any sample with the low-light microscopic images of multiple angles of the any sample to obtain the multiple depth map-low-light microscopic image pairs; and
an image enhancement module, used to input the multiple depth map-low-light microscopic image pairs into the image enhancement model to obtain the high-signal-to-noise-ratio images of multiple angles of the any sample.

It can be seen from the above technical solutions that compared with the prior art, the present disclosure provides a low-light microscopic image enhancement method and system based on a scanning light field, in which low-light-intensity illumination is performed at the illumination end, and the acquisition end performs shooting through a scanning light field microscope, thereby reducing photodamage simultaneously from illumination to acquisition, and a neural network is combined to extract depth information of the low-light images of multiple angles, and the low-light images are enhanced with the extracted depth information in combination with the neural network, thereby greatly reducing phototoxicity and simultaneously achieving high-quality microscopic image capture, and providing an effective technical means for long-term high-resolution living body microscopic observations.

### BRIEF DESCRIPTION OF DRAWINGS

In order to more clearly illustrate the technical solutions in the embodiments of the present disclosure or in the prior art, the drawings required for use in the description of embodiments or the prior art will be briefly introduced below. Obviously, the drawings described below are only embodiments of the present disclosure. For a person ordinarily skilled in the art, other drawings may be obtained based on the provided drawings without paying creative work.

The SOLE FIGURE is a schematic flowchart of the method provided by the present disclosure.

### DETAILED DESCRIPTION OF EMBODIMENTS

The technical solutions in the embodiments of the present disclosure will be clearly and completely described below in conjunction with the drawings in the embodiments of the present disclosure. Obviously, the described examples are only some of the embodiments of the present disclosure, not all of the embodiments. Based on the embodiments of the present disclosure, all other embodiments obtained by a person ordinarily skilled in the art without creative work fall within the scope of protection of the present disclosure.

On the one hand, the embodiment discloses a low-light microscopic image enhancement method based on a scanning light field, which utilizes the unique feature of providing multi-angle high-resolution microscopic images of the scanning light field, performs information extraction on the low-light microscopic images of multiple angles through a neural network to obtain a corresponding depth map, and inputs the depth map and the low-light image into another neural network for image enhancement to obtain high-resolution high-signal-to-noise-ratio microscopic images of different angles. The specific steps are as shown in the sole figure and include:
step 1: acquiring the data to be enhanced, which is low-light microscopic images of multiple angles of any sample;
step 2: inputting the low-light microscopic images of multiple angles of the any sample into the depth reconstruction model to obtain a depth map of the any sample;
step 3: pairing the depth map of the any sample with the low-light microscopic images of multiple angles of the any sample to obtain multiple depth map-low-light microscopic image pairs; and
step 4: inputting the multiple depth map-low-light microscopic image pairs into the image enhancement model to obtain the high-signal-to-noise-ratio images of multiple angles of the any sample.

In one embodiment, the same training set is used in the training processes of the depth reconstruction model and the image enhancement model, and the training set includes low-light microscopic images, high-signal-to-noise-ratio images, and depth maps of multiple angles of various samples.

In one embodiment, the method for obtaining data in the training set includes:
performing multi-angle shooting on the various samples to obtain high-signal-to-noise-ratio images of multiple angles;
processing the high-signal-to-noise-ratio images of multiple angles using a degradation and noise model to obtain low-light microscopic images of multiple angles; and
using a light field depth estimation algorithm based on the high-signal-to-noise-ratio images of multiple angles to obtain depth maps.

Further, the specific steps of constructing the training set include: establishing a light field image dataset I of various biological tissue samples, where the dataset includes low-light images

$${I}_{low}^{1} , {I}_{low}^{2} , … , {I}_{low}^{k} ,$$

high-signal-to-noise-ratio images

$${I}_{high}^{1} , {I}_{high}^{2} , … , {I}_{high}^{k}$$

and depth maps I_{depth} of K angles of various cell tissue samples, where a scanning light field microscope is used to shoot the various biological tissue samples to obtain high-signal-to-noise-ratio images

$${I}_{high}^{1} , {I}_{high}^{2} , … , {I}_{high}^{k} ;$$

and then processing the high-signal-to-noise-ratio images using a degradation and noise model to obtain low-light images

$${I}_{low}^{1} , {I}_{low}^{2} , … , {I}_{low}^{k} ,$$

where I_{low}=H(I_{high})+N, H indicates the degradation model, including but not limited to a linear motion degradation, a Gaussian degradation, a color gamut space gamma transform and other methods for reducing image brightness, and N indicates noise, including but not limited to Poisson noise, Gaussian noise, etc.; and simultaneously calculating, through a light field depth estimation algorithm, the depth map I_{depth} of the corresponding cell tissue sample based on the multi-view images, where the light field depth estimation algorithm includes but not limited to an EPI-based light field depth estimation algorithm, a method based on multiple views, a focus stack-based method and a deep learning-based method.

In one embodiment, the construction step of the depth reconstruction model includes:
constructing an initial depth reconstruction model based on a convolutional neural network; and
performing iterative training on the initial depth reconstruction model based on low-light microscopic images of multiple angles and the corresponding depth maps to obtain a depth reconstruction model.

In one embodiment, the depth reconstruction model includes an image feature extraction module, a feature fusion module and a disparity regression module.

Further, the specific steps of constructing the depth reconstruction model include: building a convolutional neural network Depth_CNN for depth reconstruction, inputting the low-light images of K angles

$${I}_{low}^{1} , {I}_{low}^{2} , … , {I}_{low}^{k}$$

into the Depth_CNN, outputting an estimated depth map I′_{depth} where the Depth_CNN consists of an image feature extraction module, a feature fusion module, and a disparity regression module; first, inputting the low-light images of K angles

$${I}_{low}^{1} , {I}_{low}^{2} , … , {I}_{low}^{k}$$

to the image nature extraction module to perform feature extraction, where the extracted features include but not limited to color features, texture features, shape features and spatial relationship features, then inputting the extracted features into the feature fusion module for feature fusion, where the feature fusion methods used include but not limited to weighted averaging, feature connectiing, feature selectiing, feature transforming and other methods, and finally, using the disparity regression module to reconstruct the disparity and depth map of the fused features:

$${I}_{depth}^{′} = Depth\_CNN ( {I}_{low}^{1} , {I}_{low}^{2} , … , {I}_{low}^{k} ) ;$$

In this embodiment, the corresponding loss function L_{depth} is calculated based on the depth map I′_{depth} output by the convolutional neural network Depth_CNN and the ground-truth depth map I_{depth} in the training set:

$${ℒ}_{depth} = {loss}_{depth} ( {I}_{depth}^{′} , {I}_{depth} ) ;$$

and
the convolutional neural network Depth_CNN is trained based on L_{depth}, where the trained network may output the corresponding depth maps by inputting low-light images of multiple angles of the cell tissue samples.

In one embodiment, the construction step of the image enhancement model includes:
constructing an initial image enhancement model based on a convolutional neural network; and
performing iterative training on the initial image enhancement model based on the depth map-low-light microscopic image pairs and high-signal-to-noise-ratio images of multiple angles to obtain an image enhancement model.

In one embodiment, the image enhancement model includes an image feature extraction module, a depth feature extraction module, a feature fusion and enhancement module and a feature regression and reconstruction module.

In this embodiment, the specific steps of constructing the image enhancement model include: building an enhanced convolutional neural network E_CNN, pairing the low-light images of K angles

$${I}_{low}^{1} , {I}_{low}^{2} , … , {I}_{low}^{k}$$

respectively with the depth map I_{depth}, and sequentially inputting into the enhanced convolutional neural network E_CNN to obtain high-resolution and high-signal-to-noise-ratio microscopic images of K angles

$${I}_{E\_CNN}^{1} , {I}_{E\_CNN}^{2} , … {I}_{E\_CNN}^{k}$$

output by the network, where E_CNN consists of an image feature extraction module, a depth feature extraction module, a feature fusion and enhancement module, and a feature regression and reconstruction module; first, inputting the low-light images of K angles

$${I}_{low}^{1} , {I}_{low}^{2} , … , {I}_{low}^{k}$$

into the image feature extraction module to perform feature extraction, and simultaneously inputting the depth map I_{depth} into the depth feature extraction module to perform depth feature extraction, where the extracted features include but not limited to color features, geometric structure features, and feature descriptors based on key points; then inputting the extracted image features and depth map features into the feature fusion and enhancement module together, where the fusion methods include but not limited to weighted averaging, feature connecting, feature selecting, feature transforming, and other methods, and the image enhancement is to perform operations, including but not limited to flipping, rotating, cropping, filling, scaling, rotating, noise blurring, and random color transformation, on the data; and finally, inputting the output features into the feature regression and reconstruction module to obtain high-resolution and high-signal-to-noise-ratio microscopic images of K angles

$${I}_{E\_CNN}^{1} , {I}_{E\_CNN}^{2} , … {I}_{E\_CNN}^{k} :$$

$${I}_{E\_CNN}^{1} = E\_CNN ( {I}_{low}^{1} , {I}_{depth} ) ;$$

$${I}_{E\_CNN}^{2} = E\_CNN ( {I}_{low}^{2} , {I}_{depth} ) ;$$

$$⋮$$

$${I}_{E\_CNN}^{k} = E\_CNN ( {I}_{low}^{k} , {I}_{depth} ) ;$$

calculating the corresponding loss function using the high-resolution and high-signal-to-noise-ratio microscopic images of K angles

$${I}_{E\_CNN}^{1} , {I}_{E\_CNN}^{2} , … {I}_{E\_CNN}^{k}$$

output by the enhanced convolutional neural network E_CNN and the high-signal-to-noise-ratio ground-truth images

$${I}_{high}^{1} , {I}_{high}^{2} , … , {I}_{high}^{k}$$

in the training set:

$${ℒ}_{image} = {loss}_{image} ( {I}_{E\_CNN}^{1} , {I}_{high}^{1} ) + {loss}_{image} ( {I}_{E\_CNN}^{2} , {I}_{high}^{2} ) + … + {loss}_{image} ( {I}_{E\_CNN}^{k} , {I}_{high}^{k} ) ;$$

and
training the enhanced convolutional neural network E_CNN based on the L_{image}, where the trained network may perform image enhancement on the input depth map and low-light images to obtain a high-resolution and high-signal-to-noise-ratio microscopic image.

After the training of the depth reconstruction neural network Depth_CNN and the enhanced convolutional neural network E_CNN is completed, a scanning light field microscope is used to collect low-light microscopic images of multiple angles of the sample. First, these images are input into Depth_CNN to obtain the depth map of the sample, which is then paired with the low-light microscopic images of different angles and input into E_CNN to obtain high-signal-to-noise-ratio images of different angles.

In the present disclosure, low-light-intensity illumination is applied at the illumination end, and shooting is performed at the acquisition end using a scanning light field microscope, thereby reducing photodamage simultaneously from illumination to acquisition, and depth information extraction is performed on the low-light images of multiple angles in combination with a neural network. The extracted depth information is combined with a neural network to enhance the low-light image, thereby greatly reducing phototoxicity and simultaneously achieving high-quality microscopic image capture, and providing an effective technical means for long-term and high-resolution living body microscopic observation.

On the other hand, this embodiment further discloses a low-light microscopic image enhancement system based on a scanning light field, including:
a data acquisition module used to acquire the data to be enhanced, where the data to be enhanced is low-light microscopic images of multiple angles of any sample;
a depth reconstruction module used to input the low-light microscopic images of multiple angles of the any sample into the depth reconstruction model to obtain a depth map of the any sample;
a data grouping module used to pair the depth map of the any sample with the low-light microscopic images of multiple angles of the any sample to obtain the multiple depth map-low-light microscopic image pairs; and
an image enhancement module used to input the multiple depth map-low-light microscopic image pairs into the image enhancement model to obtain high-signal-to-noise-ratio images of multiple angles of the any sample.

In this specification, the embodiments are described in a progressive manner, and each embodiment focuses on the differences from other embodiments. The same or similar parts between the embodiments may be referred to each other. For the device disclosed in the embodiment, since it corresponds to the method disclosed in the embodiment, the description is relatively simple, and the relevant parts can be referred to the method parts.

The above description of the disclosed embodiments enables one skilled in the art to implement or use the present disclosure. Various modifications to these embodiments will be apparent to one skilled in the art, and the general principles defined herein may be implemented in other embodiments without departing from the spirit or scope of the present disclosure. Therefore, the present disclosure will not be limited to the embodiments shown herein, but rather to the widest scope consistent with the principles and novel features disclosed herein.

1. A low-light microscopic image enhancement method based on a scanning light field, comprising specific steps of:
obtaining data to be enhanced, wherein the data to be enhanced is low-light microscopic images of multiple angles of any sample;
inputting the low-light microscopic images of multiple angles of the any sample into a depth reconstruction model to obtain a depth map of the any sample;
pairing the depth map of the any sample with the low-light microscopic images of multiple angles of the any sample to obtain multiple depth map-low-light microscopic image pairs; and
inputting the multiple depth map-low-light microscopic image pairs into an image enhancement model to obtain high-signal-to-noise-ratio images of multiple angles of the any sample, wherein a construction step of the depth reconstruction model comprises:
constructing an initial depth reconstruction model based on a convolutional neural network; and
performing iterative training on the initial depth reconstruction model based on the low-light microscopic images of multiple angles and the corresponding depth maps to obtain the depth reconstruction model;
wherein a construction step of the image enhancement model comprises:
constructing an initial image enhancement model based on a convolutional neural network; and
performing iterative training on the initial image enhancement model based on the depth map-low-light microscopic image pairs and the high-signal-to-noise-ratio images of multiple angles to obtain the image enhancement model.

2. The low-light microscopic image enhancement method based on a scanning light field according to claim 1, wherein a same training set is used in training processes of the depth reconstruction model and the image enhancement model, and the training set comprises the low-light microscopic images, the high-signal-to-noise-ratio images and the depth maps of multiple angles of various samples.

3. The low-light microscopic image enhancement method based on a scanning light field according to claim 2, wherein a method for acquiring data in the training set comprises:
performing multi-angle shooting on the various samples to obtain the high-signal-to-noise-ratio images of multiple angles;
processing the high-signal-to-noise-ratio images of multiple angles using a degradation and noise model to obtain the low-light microscopic images of multiple angles; and
using a light field depth estimation algorithm based on the high-signal-to-noise-ratio images of multiple angles to obtain the depth map.

4. The low-light microscopic image enhancement method based on a scanning light field according to claim 1, wherein the depth reconstruction model comprises an image feature extraction module, a feature fusion module and a disparity regression module.

5. The low-light microscopic image enhancement method based on a scanning light field according to claim 1, wherein the image enhancement model comprises an image feature extraction module, a depth feature extraction module, a feature fusion and enhancement module and a feature regression and reconstruction module.

6. A low-light microscopic image enhancement system based on a scanning light field, comprising:
a data acquisition module, configured to acquire data to be enhanced, wherein the data to be enhanced is low-light microscopic images of multiple angles of any sample;
a depth reconstruction module, configured to input the low-light microscopic images of multiple angles of any sample into the depth reconstruction model to obtain a depth map of the any sample, wherein the depth reconstruction model is obtained by performing iterative training on an initial depth reconstruction model constructed based on a convolutional neural network, by using the low-light microscopic images of multiple angles and the corresponding depth maps;
a data grouping module, configured to pair the depth map of the any sample with the low-light microscopic images of multiple angles of the any sample, so as to obtain multiple depth map-low-light microscopic image pairs; and
an image enhancement module, configured to input the multiple depth map-low-light microscopic image pairs into the image enhancement model to obtain high-signal-to-noise-ratio images of multiple angles of the any sample, wherein the image enhancement model is obtained by performing iterative training on an initial image enhancement model constructed based on a convolutional neural network, by using the depth map-low-light microscopic image pairs and the high-signal-to-noise-ratio image pairs of multiple angles.
